(19) United States
(12) Patent Application Publication
(10) Pub. No.: US 2018/0060955 A1
(43) Pub. Date: Mar. 1, 2018

(54) System for Synthesizing Financial Transaction Parameters and Method of Executing Financial Transactions Based Thereon

(71) Applicant: John Netto, San Bruno, CA (US)

(72) Inventor: John Netto, San Bruno, CA (US)

(73) Assignee: The Protean Trader, LLC, Las Vegas, NV (US)

(21) Appl. No.: 15/250,746

(22) Filed: Aug. 29, 2016

(51) Int. Cl. G06Q 40/04

(52) U.S. Cl. CPC G06Q 40/04

(57) ABSTRACT

Provided is a computerized system for synthesizing financial transaction parameters and method of executing financial decisions. The system and method utilize at least one economic event selected by the user, at least one numerical expression contextualizing the user's evaluation of such selected events, and a set of specified order details (scenarios) corresponding to a set range of the previously determined numbers. The system executes the order in real time according to the scenario based on the received events. The present system facilitates portfolio management by providing users a centralized and intuitive interface that aggregates, in an organized fashion, decision making parameters and ordering heuristics.

This application claims priority to U.S. Provisional Patent Application Ser. No. 62/211,634, filed Aug. 28, 2015, titled the same and incorporated herein as if set out in full.

### FIELD OF THE INVENTION

The present invention relates generally to computing services accessible via an interactive computer network and, in particular, remote computing services accessible via web and mobile application interfaces to provide a system by which users may receive real-time market and government embargoed data, create metrics by which synthetic parameters are determined, and heuristically place multiple market orders simultaneously.

### BACKGROUND OF THE INVENTION

Global investment advisors, money managers, hedge funds proprietary desks and broker dealers, with access to global trading venues, proprietary trading algorithms, execution consulting services, and pre-and-post trade analytics perform research on a daily basis. Current services available on the market provide users trading platforms integrated with professional services and proprietary algorithms to provide trading solutions for equities, futures, option, and foreign exchange to manage trading strategies in multiple exchanges.

Brokerage firms have traditionally allowed individual investors to specify certain trading orders with buy or sell limits, prescribing that a trade not be executed unless a certain price level for the transaction might become available in the market exchange within a certain limited time frame, usually designated as within one trading day.

In a similar manner, these investor trading orders might ordinarily be further conditioned on other circumstances. A market order is executed at the best price obtainable at the time the order is executed. A dynamic order on the other hand, does guarantee the price but does not guarantee an execution. Dynamic orders are entered after a designated number of “ticks” at the designated asking price.

Complex order logic and risk management logic are used in determining these order parameters. Often times the user needs to contextualize an event against other events and alter specifications of an order within that context. As the extended capabilities of online communication become more commonly available, there is an expanded possibility for trading and managing the risk around economic numbers integrated into one user interface.

A need exists for a system and method that integrates one or more market and synthetic parameters to create at least one order heuristic. The present invention satisfies the demand through an efficient and integrated system and method for trade order entry and execution, with the ability to place multiple trades simultaneously and accurately, based on real time contextualized economic events and breaking news.

### Description of the Prior Art

U.S. Pat. No. 8,131,625 CUSTOMIZABLE TRADING DISPLAY OF MARKET DATA discloses methods for providing a customizable trading display of market instrument data including selecting a subset from a plurality of quadrants, each quadrant associated with one benchmark instrument and at least one non-benchmark instrument, each non-benchmark instrument associated with the benchmark instrument. Multiple quadrants of customizable, tabbed displays are presented. Each customizable display reflects one of a plurality of benchmark and non-benchmark instruments, e.g. a bond, futures contract, stock, debt instrument, or equity. Market data is automatically retrieved for the instruments associated with each selected quadrant. A graphical user interface (“GUI”) having customizable, interactive frames or views having pull-down lists and buttons is described as is the ability to use that same GUI to issue trade commands and view active orders, trade history, market history, or other status information. The GUI quadrants themselves adjust depending on which and how many instruments are simultaneously being displayed.

The '625 patent does not disclose the present system's ability generate contextualized event information and quantify one or more economic events into a numerical expression. The system and method disclosed in '625 also lacks the ability to simulate trading activity.

U.S. Pat. No. 8,849,711 SYSTEM AND METHOD FOR DISPLAYING A COMBINED TRADING AND RISK MANAGEMENT GUI DISPLAY discloses a system that provides risk management and financial surveillance to protect all clearing members and their customers from the consequences of a default by a participant in the clearing process. The disclosed GUI comprises both automated and real-time execution controls, product position data, and a “‘what if’ Scenario Panel.” This “‘what if’ Scenario Panel” allows the user to experiment with “what-if” scenarios in real time or on an as-needed basis, to see the potential effects on margin requirements.

The Scenario Panel largely comprises the '711 patent's utilization of the proprietary Standard Portfolio Analysis of Risk (SPAN®) metric, the Theoretical Intermarket Margin System (“TIMS”), and the OMS II system.

Graphically, the '711 patent discloses a GUI with scroll bars and buttons, menus, pop-ups, gauges, and other features. The '711 patent's GUI is responsive (i.e., it can be utilized on desktops and mobile devices) and contains margin information, “what if,” actuals, and asset/collateral valuation panels. FIG. 2D is the illustrated embodiment of the reference's “what if” panel.

These prior art references, though relevant, do not disclose the unique process presented in the present system: at least one economic event is selected by the user, at least one numerical expression contextualizes the user's evaluation of such selected events, a set of specified order details (scenarios) corresponds to a set range of the previously determined numbers, and the system executes the order in real time according to the scenario according to the received events.

The present system facilitates portfolio management by providing users a centralized and intuitive interface that aggregates, in an organized fashion, decision making parameters and ordering heuristics.

### SUMMARY OF THE INVENTION

The present invention is a computerized, native or remotely-accessible system that integrates external data feeds including, without limitation, government embargoed data, and the ability to incorporate the data feeds to create synthetic multi-parameter and multi-scenario ordering, complex order logic, and order specification alteration based on the data feed and market price action (“MPACT”). The MPACT allows users to base order decision making on aggregating the results of multiple events in addition to a user-defined, synthetic parameter (“Netto Number”). To create the Netto Number, users grade events (e.g., release of U.S. employment data) by assigning one or more scores to one or more outcomes of the event.

The user structures an order set by creating various scenarios under which orders on one or more contracts will be placed. Upon the release of economic, political, or market data—which is integrated with the MPACT over computer networks and in real time—a particular scenario may be activated and the orders therein executed as they are configured within that scenario. The MPACT intuitively integrates front-end electronic trading analytics and order routing technology to centralize order management processes.

### BRIEF DESCRIPTION OF THE DRAWINGS

The accompanying figures and drawings, incorporated into and forming part of the specification, serve to further illustrate the present invention, its various principles and advantages, and its varying embodiments:

FIG. 1 depicts an exemplary MPACT system integration of real time market data to synthesize parameters and send orders based on single or multiple events according to one embodiment of the present invention.

FIG. 2 depicts an exemplary event configuring GUI according to one embodiment.

FIG. 3 depicts an exemplary Single Event Trading process according to one embodiment of the present invention.

FIGS. 3A-3C depict an exemplary Single Event Trading GUI according to one embodiment of the present invention.

FIG. 4 illustrates an exemplary Multiple Event Trading process according to one embodiment of the present invention.

FIGS. 4A-4D detail an exemplary MPACT GUI order configuration window according to one embodiment of the present invention.

FIG. 5 illustrates an exemplary Synthetic Parameters Trading process according to one embodiment of the present invention.

FIGS. 5A-5D detail an exemplary MPACT GUI order configuration window according to one embodiment of the present invention.

FIGS. 6A-6C detail an exemplary MPACT GUI audit window according to one embodiment of the present invention.

FIGS. 7A-7B depict an exemplary historical data aggregation window according to one embodiment of the present invention.

FIG. 8 depicts an exemplary MPACT GUI order aggregation window illustrating, in filterable fashion, status for orders.

### DETAILED DESCRIPTION OF THE ILLUSTRATED EMBODIMENTS

I. Introduction

Provided is a computerized trading platform, operable from a non-transitory computer readable medium, which integrates front-end market data providers (e.g., AlphaFlash®), order routing technology (e.g., CQG®), and heuristic order logic predicated upon both raw event outcome and synthetic parameters (e.g., aggregate event outcomes).

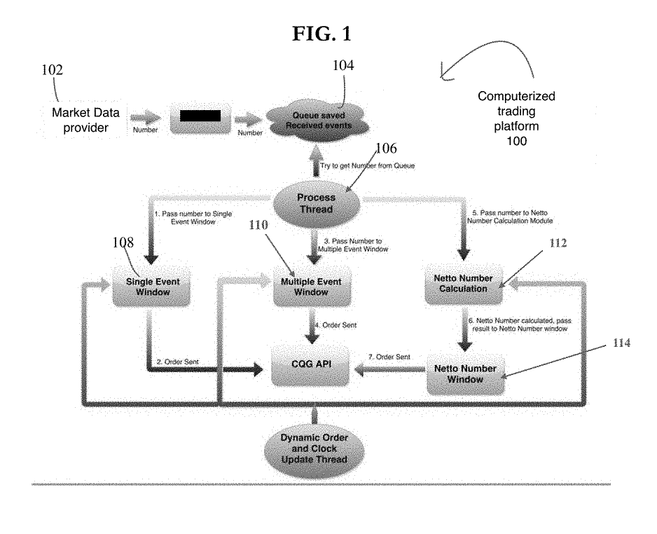

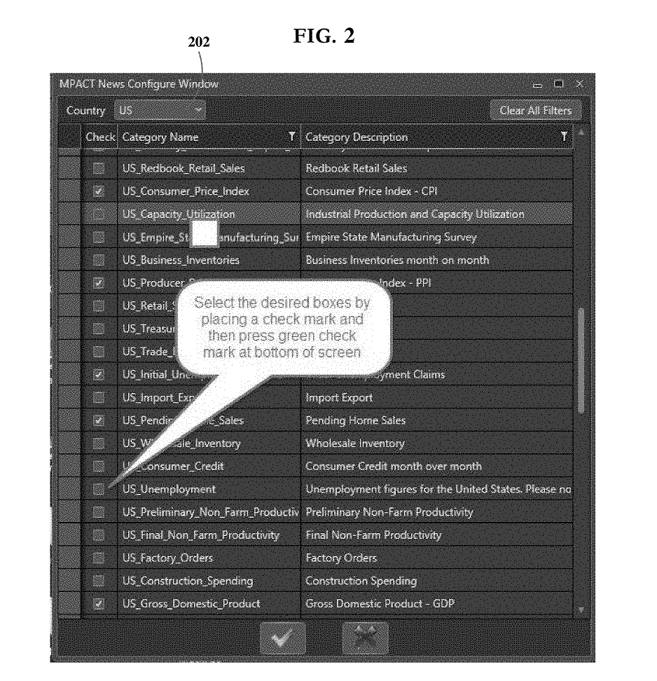

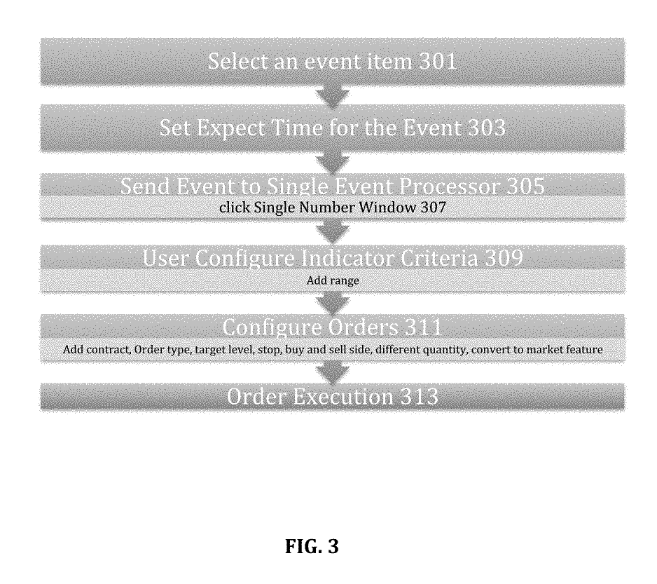

With reference to the embodiment illustrated in FIG. 1, the MPACT system 100 pulls in the real time event data from a front-end market data provider 102. The real time events received by the system 100 are saved and displayed to the users when the users open the news configuration window (as illustrated in FIG. 2A) at step 104 as illustrated in FIG.1.

An exemplary list of events intakes by the system 100 in FIG. 1 is illustrated in FIG. 2. These events include real-time market and government embargoed data. The user may select an event feed by filtering individual country 202. The user selects desired feeds and then imports the feeds into the MPACT process flow 106 as illustrated in FIG.1.

II. Single Event, Multiple Event and Synthetic Parameters Trading.

1. Single Event Trading

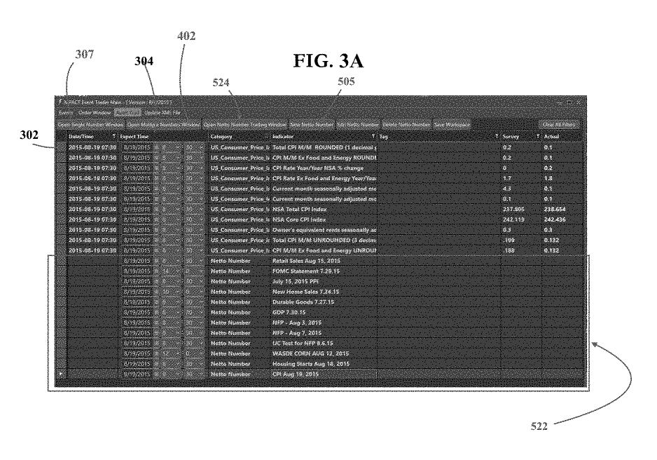

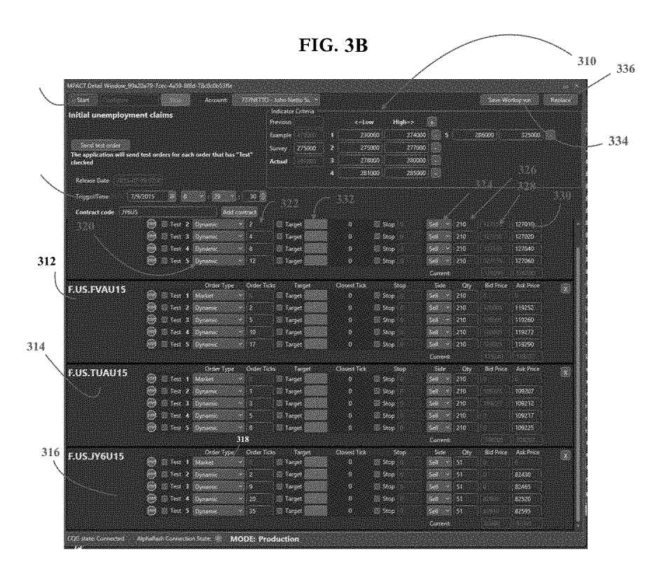

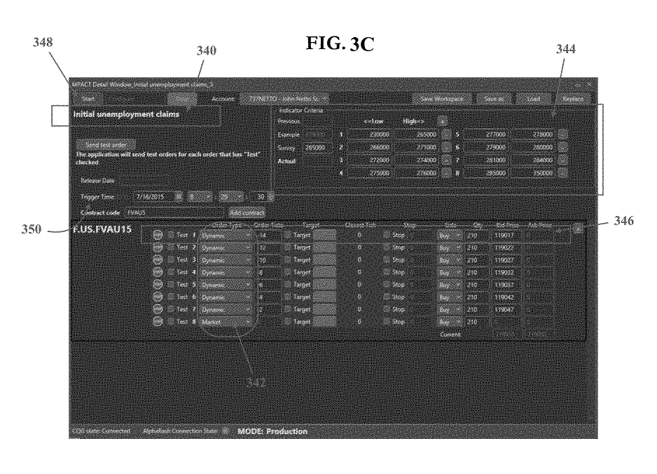

FIG. 3 illustrates an exemplary Single Event process presented in the Single Event Window 108 in FIG. 1. A list of events are presented in an exemplary Event Trader Main Window illustrated in FIG. 3A. At step 301 in FIG. 3, one new event item is selected by the user from the listed events by clicking one of the boxes 302 in FIG. 3A. After the event is selected, the user sets expected time for the selected event at step 303 in FIG. 3. (See Expected Time column 304 in FIG. 3A.) The next step 305 is to send the selected event to the Single Event Processor through clicking the “Open Single Number Window” tab 307 as illustrated in FIG. 3A. An MPACT Detail Window as illustrated in FIG. 3B will therefore be called and opened upon the clicking of tab 307.

FIG. 3B illustrates an exemplary MPACT GUI order configuration window based on an unemployment data-related event. The user first configures the Indicator Criteria at step 309 in FIG.3. This step can be accomplished through the Indicator Criteria Box 310 illustrated in FIG. 3B. In the illustrated embodiment, the user sets five sets of ranges (the first set has a range from 230000 to 274000, the second set has a range from 275000 to 277000, the third set has a range from 278000 to 280000, the fourth set has a range from 281000 to 285000, the fifth set has a range from 286000 to 325000).

Multiple contracts (e.g. F.US.FVAU15 in box 312 as illustrated in FIG. 3B, F.US.TUAU15 in box 314 as illustrated in FIG. 3B, and F.US.JY6U15 in box 316 as illustrated in FIG. 3B) are listed, each having ordering characteristics such as “Market” 318 or “Dynamic” 320 to identify the type of the order. The exemplary window in FIG. 3B illustrates the user configuring a set of purchase orders for contracts F.US.FVAU15, F.US.TUAU15, and F.US.JY6U15 based on a single event: Initial unemployment claims.

The user can also specify the order ticks in the order ticks column 322. The orders may then be entered in dynamic response to market data updates and are based on the parameters the user configured within the MPACT system under the dynamic order mode (i.e., order is entered after a designated number of ticks at the designated asking price).

Any particular order is, through MPACT, configurable as to buy or sell order side 324, quantity in question 326, and bid 328 or asking 330 price in question. In one embodiment, the MPACT system also allows the user to configure stop, close tick, target and convert to market functions. Through adding parameters like a target 332 (the target 332 being relative to entry price of the position), the user can add additional risk managing parameters to the ordering heuristics.

Whenever the user configures an order, the workspace that contains the configuration information may be saved through clicking the save workspace button 334. The saved workspace can be retrieved and further edited by the user. Further, the user may, either individually or globally, update (e.g., through the Replace button 336) expired or undesired scenarios from a workspace.

FIG. 3C illustrates the MPACT workspace with a set of purchase orders for a single event: Initial Unemployment Claims in box 340. Seven of the eight ordering characteristics are dynamic as shown in box 342—i.e., the orders are entered in dynamic response to market data updates and are based on the parameters the user sets within the MPACT window. In the indicator criteria box 344, the user has defined 8 testing ranges. When the received event matches one of the ranges defined, the contract specified under that range will be triggered. For example, if the received Initial Unemployment Claims falls under the range between 230,000 and 265,000, as shown in criteria 1, specifications in TEST 1 as presented in box 344 will be triggered.

After clicking the start button 348, the configured order(s) can then be executed at the configured trigger time 350 as illustrated in FIG. 3C, at step 313 as illustrated in FIG. 3.

2. Multiple Event Trading.

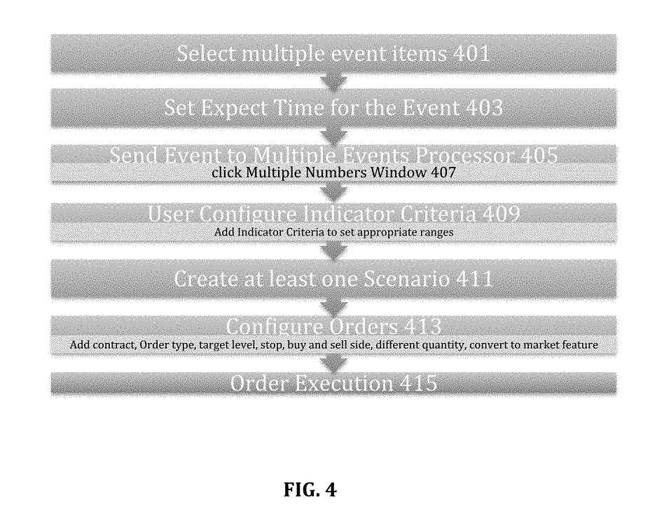

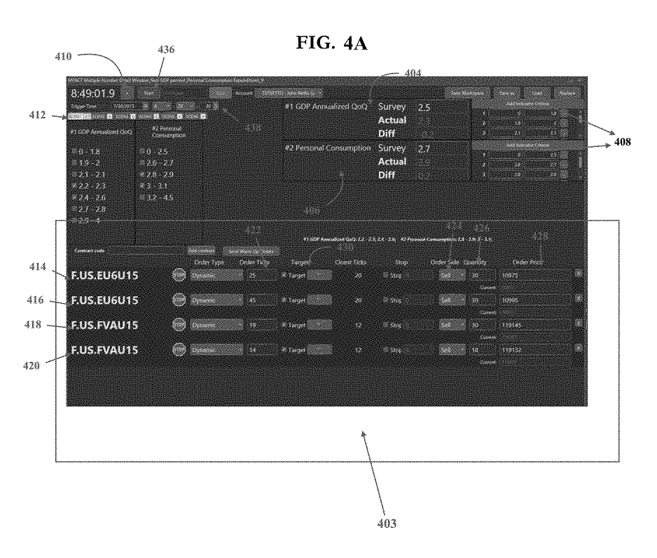

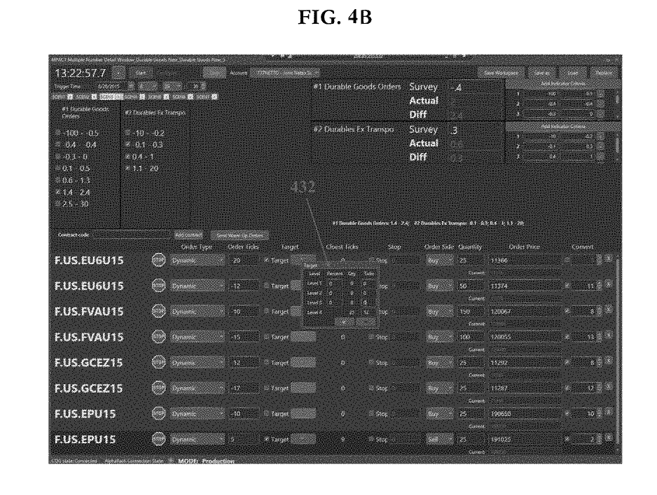

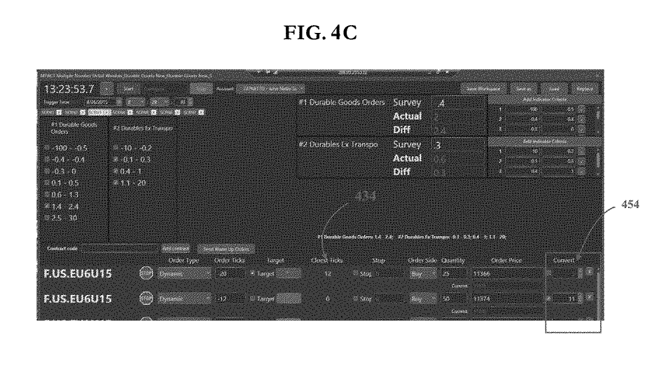

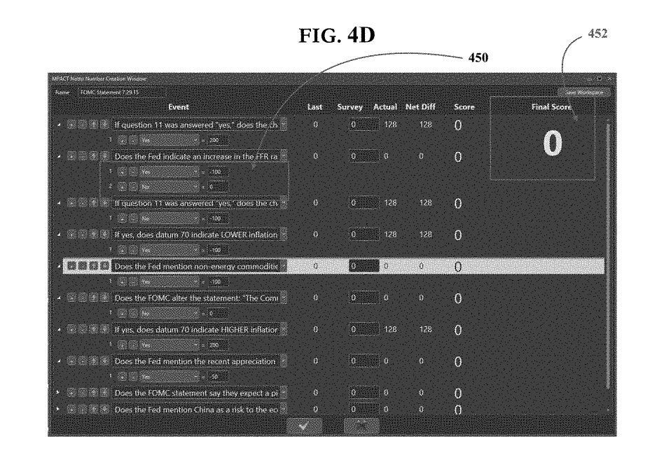

FIG. 4 illustrates an exemplary Multiple Event Trading process presented in the Multiple Event Window 110 in FIG. 1. Similar to the first step for the Single Event Trading process, a list of events are presented in an exemplary Event Trader Main Window as illustrated in FIG. 3A. At step 401 in FIG.4, at least two new event items are selected by the user from the listed events by clicking the boxes 302. After the events are selected, the user sets expected time for the selected event at step 403 in FIG. 4. (See Expected Time column 304 in FIG. 3A.) The next step 405 in FIG. 4 is to send the selected events to the Multiple Event Processor through clicking the “Open Multiple Number Window” tab 402 as illustrated in FIG. 3A. An MPACT Multiple Number Detail Window as illustrated in FIG. 4A will therefore be called and opened upon the clicking of tab 402.

Turning to FIG. 4A, an exemplary MPACT Multiple Number Detail Window 407 detailing ordering heuristics for multiple contracts based on multiple events within the context of multiple scenarios is illustrated. In the illustrated embodiment, six scenarios were created.

FIG. 4A details an exemplary MPACT GUI order configuration window based on multiple selected market events: GDP Annualized Quarter-to-Quarter market data 404 and Personal Consumption market data 406. The user first configures the Indicator Criteria at step 409 in FIG. 4. This step can be accomplished through the Indicator Criteria Boxes 408 illustrated in FIG. 4A. In the illustrated embodiment, the user sets seven sets of ranges for the GDP Annualized Quarter-to-Quarter market data 404 (the first set has a range from 0 to 1.8, the second set has a range from 1.9 to 2, the third set has a range from 2.1 to 2.1, the fourth set has a range from 2.2 to 2.3, the fifth set has a range from 2.4 to 2.6, the sixth set has a range from 2.7 to 2.8, and the seventh set has a range from 2.9 to 4).

Similarly, the user sets five sets of ranges for the Personal Consumption market data 406 (the first set has a range from 0 to 2.5, the second set has a range from 2.6 to 2.7, the third set has a range from 2.8 to 2.9, the fourth set has a range from 3 to 3.1, and the fifth set has a range from 3.2 to 4.5).

Next, the user configures at least one scenario at step 411 as illustrated in FIG. 4. By clicking the add scenario button 410 as illustrated in FIG. 4A, the user may add scenarios. Each scenario will create a tab 412. Within each scenario tab, a certain combination of range for each selected event will be selected by the user, in order to create the definition of the selected scenario.

In the illustrated embodiment, the Actual for events 404 and 406 yields 2.3 and 2.9 respectively, and therefore this combination matches all criteria defined in Scenario 1. Scenario 1, under this circumstance, will be triggered.

Scenario 1 is configured as illustrated in the order details box 403 in 4A. Multiple contracts (e.g., F.US.EU6U15 in boxes 414 and 416 as illustrated in FIG. 4A, F.US.FVAU15 in boxes 418 and 420 as illustrated in FIG. 4A) are listed, each having ordering characteristics such as “Market” or “Dynamic” similar to the configurations in the MPACT GUI order configuration window illustrated in FIG. 3B (here only Dynamic order type is illustrated).

The user can also specify the order ticks in the order ticks column 422. The orders may then be entered in dynamic response to market data updates and are based on the parameters the user configured within the MPACT system under the dynamic order mode (i.e., order is entered after a designated number of ticks at the designated asking price).

Any particular order is, through MPACT, configurable as to buy or sell order side 424, quantity in question 426, and order price 428 in question. In one embodiment, the MPACT system also allows the user to configure stop, closest tick, target and convert to market functions. Through adding parameters like a target 430 (the target 430 being relative to entry price of the position), the user can add additional risk managing parameters to the ordering heuristics. An exemplary window showing the user adding a target is illustrated in FIG. 4B. In FIG. 4B, the user selects a target for a Euro currency contract (i.e., F.US.EU6U15) via the MPACT Multiple Number Detail Window by inputting the target into a dropdown field 432, the target being relative to entry price of the position. FIG. 4C illustrates the MPACT Multiple Number Detail Window after the user has set a target of Closest Ticks 434 of 12 for the Euro currency contract.

The convert to market function is also illustrated in FIG. 4C. The convert to market function adds further flexibility in the scenario creation process. As a result of the MPACT dynamic-to-market feature, based on the user's predefined criteria 454, dynamic orders will be automatically cancelled and be replaced with market orders. This dynamic-to-market feature is best used when the user first wants to execute a dynamic order, but later due to the change of the market the dynamic order becomes unrealistic. Under such situation, when the criteria defined by the user are triggered, the original dynamic order will be automatically converted into a market order, which means the order will be executed based on the market.

FIG. 4D details the scoring of the event sub-criteria for qualitative market data. For example, the user may assign scores to “yes” and “no” answers in box 450 to qualitative questions provided through the real-time market and government embargoed data feeds. The sub-criteria scores are aggregated to create the Netto Number 452. The MPACT Netto Number generation works in similar fashion for quantitative market data.

After clicking the start button 436 in FIG. 4A, the configured order(s) can then be executed at the configured trigger time 438 as illustrated in FIG. 4A, at step 415 as illustrated in FIG. 4.

Just as illustrated in the Single Event Trading function, whenever the user configures an order, the workspace that contains the configuration information may be saved. The saved workspace can be retrieved and further edited by the user. Further, the user may, either individually or globally, update expired or undesired contracts from a workspace.

3. Synthetic Parameters Trading.

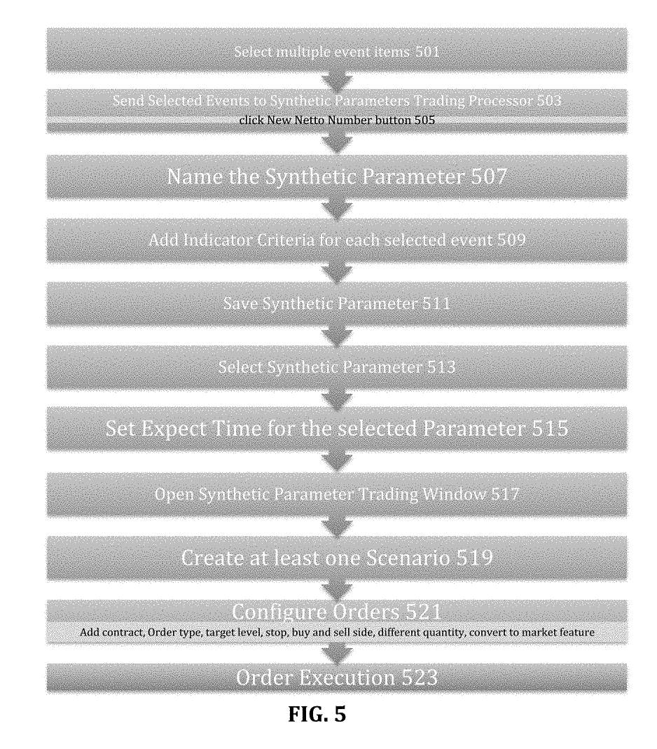

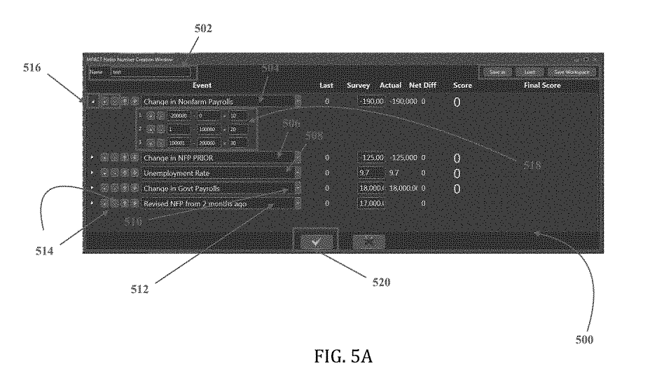

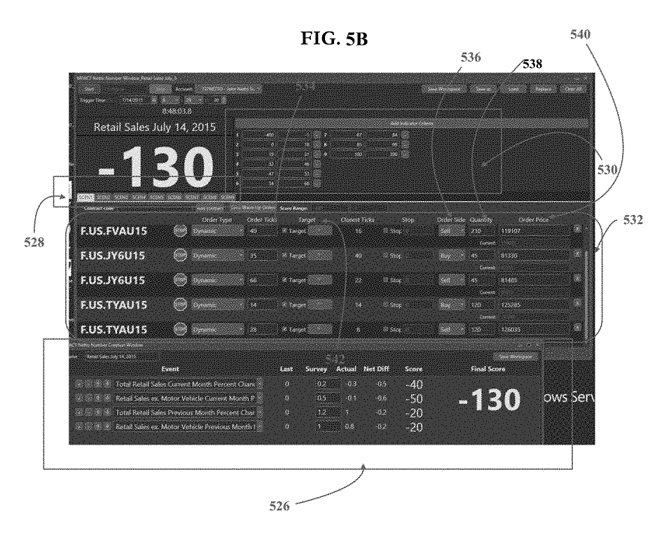

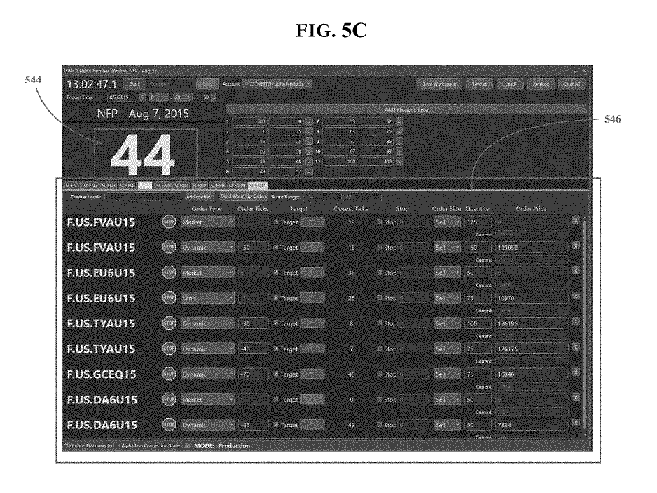

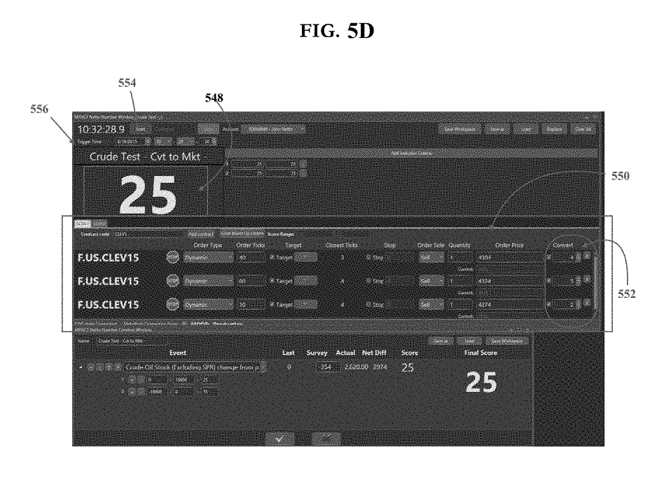

FIG. 5 illustrates an exemplary Synthetic Parameters Trading process presented in the Netto Number Calculation Box 112 and Netto Number Window 114 in FIG. 1. Similar to the first step for the Single Event Trading process and the Multiple Event Trading Process, a list of events are presented in an exemplary Event Trader Main Window as illustrated in FIG. 3A.

At step 501 in FIG. 5, at least two new event items that the user wishes to include into this Synthetic Parameter are selected by the user from the listed events by clicking the boxes 302. The next step 503 in FIG. 5 is to send the selected events to the Synthetic Parameters Trading Processor through clicking the “New Netto Number” tab 505 as illustrated in FIG. 3A. A Synthetic Parameters Trading Processor as illustrated in FIG. 5A will therefore be called and opened upon the clicking of tab 505.

Turning to FIG. 5A, an exemplary MPACT Netto Number Creation Window 500 detailing multiple events within the context of multiple scenarios is illustrated. The user must name the Synthetic Parameter at step 507 as illustrated in FIG. 5. This name 502 as illustrated in FIG. 5A has to be unique in order to properly identify this Synthetic Parameter at the Synthetic Parameter Trading Process illustrated hereinafter.

In the illustrated embodiment in FIG. 5A, five events are selected in order to generate the Netto Number: Change in Nonfarm Payroll 504, the change in NFP PRIOR 506, Unemployment Rate 508, Change in Government Payrolls 510, and Revised NFP from 2 months ago 512. The selected events can be added or removed by clicking the “+/−” buttons 514. By clicking the expand button 516 the user can expand the criteria under a certain event to add Indicator Criteria for each selected event at step 509 in FIG. 5.

In FIG. 5A, the illustrated embodiment shows that the user configures three ranges 518 for the Change in Nonfarm Payrolls (i.e., the first range from −200,000 to 0, which leads to a score of 10; the second range from 1 to 100,000, which leads to a score of 20; and the third range from 100,001 to 200,000, which leads to a score of 30). The user configures the criteria for all events, and through clicking the save button 520, the generated Synthetic Parameter is saved (see step 511 in FIG. 5).

Referring back to FIG. 3A, multiple Netto Numbers in box 522 have already been generated through the user. From these available previously generated Synthetic Parameters, the user may select a Netto Number at step 513 in FIG. 5. After the events are selected, the user sets expected time for the selected event at step 515 in FIG. 5. (See Expected Time column 304 in FIG. 3A.).

The next step 517 in FIG. 5 is to configure the Synthetic Parameter Trading process through clicking the “Netto Number Trading Window” tab 524 as illustrated in FIG. 3A. An MPACT Netto Number Window as illustrated in FIG. 5B will therefore be called by the system and opened upon the clicking of tab 524.

Turning to FIG. 5B, an exemplary MPACT Netto Number Window detailing ordering heuristics for multiple contracts based on the selected Netto Number within the context of multiple scenarios is illustrated. In the illustrated embodiment, nine scenarios were created. A collapsed Netto Number Creation Window 526 indicates that, based on the user's selected events and sub-criteria scoring, the Netto Number was calculated at −130.

The system requires the user to create at least one scenario at step 519 as illustrated in FIG.5. In the illustrated embodiment in FIG. 5B, the user created nine ordering scenarios 528, each of which corresponded to a range in which the Netto Number would arrive (i.e., the first scenario ranges from −400 to −1, the second scenario ranges from 0 to 18, the third scenario ranges from 19 to 31, the fourth scenario ranges from 32 to 46, the fifth scenario ranges from 47 to 53, the sixth scenario ranges from 54 to 66, the seventh scenario ranges from 67 to 84, the eighth scenario ranges from 85 to 99, and the ninth scenario ranges from 100 to 300 according to the indicator criteria added by the user to box 530).

Under each scenario, the user then configures the orders corresponding to each scenario as illustrated in step 521 in FIG. 5. This order configuration process is similar to the order configuration process illustrated in the Single Event Trading and Multiple Event Trading processes.

In the embodiment illustrated in FIG. 5B, Scenario 1 is configured as illustrated in order details box 532. Multiple contracts (i.e., F.US.FVAU15, F. USJY6U15, and F.US.TYAU15) are listed, each having ordering characteristics such as “Market,” “Dynamic” or “limit” (as shown in FIG. 5C) similar to the configurations in the MPACT GUI order configuration window illustrated in FIG. 3B (here only Dynamic order type is illustrated in FIG. 5B).

The user can also specify the order ticks in the order ticks column 534. The orders may then be entered in dynamic response to market data updates and are based on the parameters the user configured within the MPACT system under the dynamic order mode (i.e., order is entered based on a designated number of ticks at the designated asking price).

Any particular order is, through MPACT, configurable as to buy or sell side 536, quantity in question 538, and order price 540 in question. In one embodiment, the MPACT system also allows the user to configure stop, close tick, target and convert to market functions. Through adding parameters like a target 542 (the target 542 being relative to entry price of the position), the user can add additional risk managing parameters to the ordering heuristics. An exemplary window showing the user adding a target is illustrated in FIG. 4B. The target adding process is similar to the process illustrated in FIG. 4B.

Similarly, FIG. 5C illustrates when a Netto Number in box 544, being calculated at 44, fell within the Scenario 5 range and thus activated that scenario's user-predefined market dynamic, and limit sale order heuristics illustrated in box 546.

The convert-to-market function for Synthetic Parameters Trading is illustrated in FIG. 5D. The convert-to-market function adds further flexibility in the scenario creation process. The illustrated embodiment in FIG. 5D shows a Netto Number in box 548 of 25 being calculated based on market data and activating Scenario 1 order configuration 550. As a result of the MPACT dynamic-to-market feature, based on the user's predefined criteria 552, dynamic orders will be automatically cancelled and be replaced with market orders. This dynamic-to-market feature is best used when the user first wants to execute a dynamic order, but later due to the change of the market the dynamic order becomes unrealistic. Under such situation, when the criteria defined by the user are triggered, the original dynamic order will be automatically converted into a market order, which means the order will be executed based on the market.

After clicking the start button 554, the configured order(s) can then be executed at the configured trigger time 556 as illustrated in FIG. 5D, at step 523 as illustrated in FIG. 5.

Just as illustrated in the Single Event Trading Window and Multiple Event Trading Window function, whenever the user configures an order, the workspace that contains the configuration information may be saved. The saved workspace can be retrieved and further edited by the user. Further, the user may, either individually or globally, update expired or undesired contracts from a workspace.

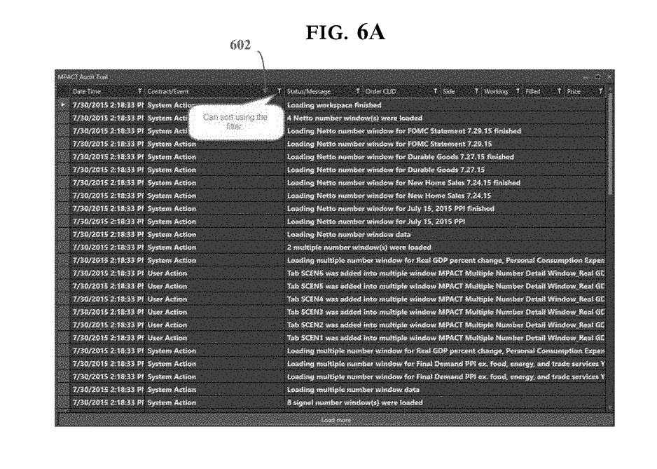

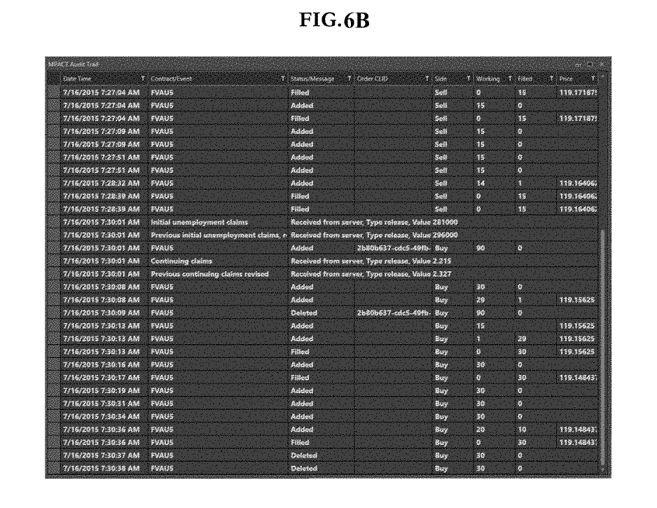

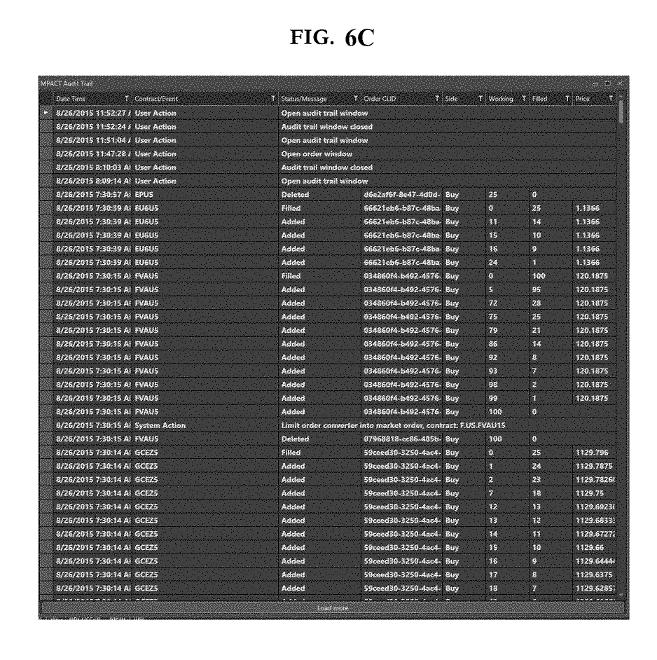

All of the above mentioned trading activities can be reviewed through the audit function of the present system. FIG. 6A illustrates an exemplary MPACT activity history window (i.e., an audit). In filterable fashion through button 602, MPACT lists the occurrence, date, and time of both system and user actions.

FIG. 6B illustrates another audit window where transaction details are identified by contract, event type, status, buy/sell side, breakdown of order completion, and at what price the completed order occurred.

FIG. 6C illustrates an itemized MPACT audit trail of user and MPACT automatic dynamic-to-market conversions over a period of time.

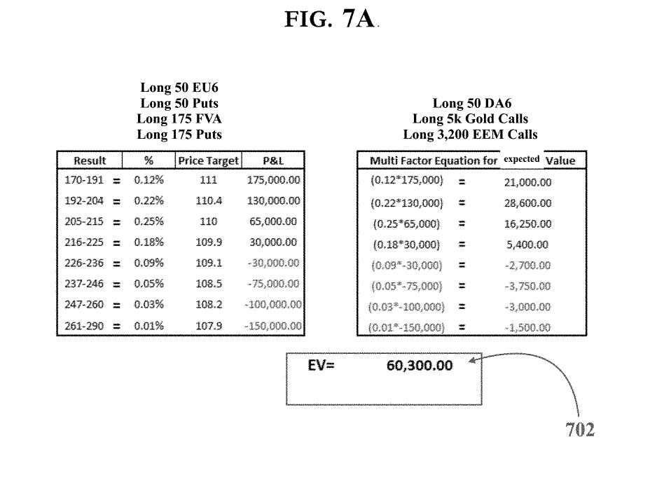

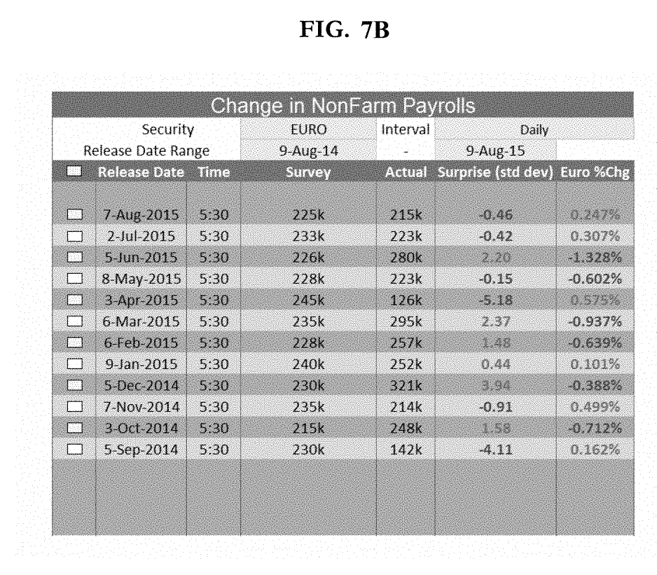

MPACT also has the ability to historically organize market and government embargoed data for forecasting and risk management purposes. FIG. 7A shows a parametric analysis deriving aggregated expected value 702 for a hypothetical portfolio based on the results of an economic event.

FIG. 7B illustrates MPACT aggregating historical data of a single statistic: Change in NonFarm Payrolls, to help forecast results.

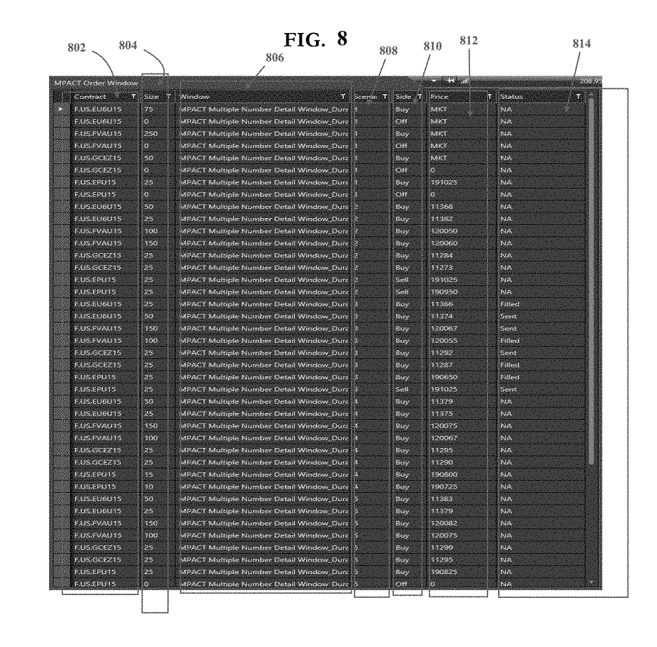

FIG. 8 depicts an exemplary MPACT GUI order aggregation window illustrating, in filterable fashion, status for orders for multiple scenarios from the illustrated Tradings. Through this window, the user can review the itemized orders, including what contracts were traded 802, at what size 804, under what Window 806 (i.e., under Single Event Trading, Multiple Event Trading, or Synthetic Number Trading), which scenario was used 808, traded from which side 810, at what price 812, and the status 814.

The above detailed descriptions relate to specific preferred embodiments as the inventor presently contemplates. It will be understood that the invention in its broad aspects includes electronic and functional equivalents of the elements described herein. Various details of design and implementations may be modified without departing from the true spirit and scope of the invention.

We claim:

1. A computerized method for synthesizing financial transaction parameters and method of executing financial decisions in a transaction system, the method comprising:
setting up intake module for intaking at least one event information from a source;
determining at least one indicator criteria for said received event information in a trading processing module;
configuring at least one ordering specifics for each said determined indicator criteria in said trading processing module;
receiving real time even information from said source in said intake module;
triggering said ordering specifics based on the indicator criteria matching said received real time event information at a order execution module.

2. The method of claim 1 wherein said trading processing module is adapted to process a single event.

3. The method of claim 1 wherein said trading processing module is adapted to process multiple events.

4. The method of claim 1 wherein said trading processing module is adapted to synthesize multiple events in a numerical form.

5. The method of claim 3 wherein said trading processing module is adapted to create at least one scenario based on at least one parameter of said indicator criteria.

6. The method of claim 4 wherein said trading processing module is adapted to create at least one scenario based on at least one parameter of said indicator criteria.

7. The method of claim 1 wherein said determinations and configurations is adapted to be saved in a workspace.

8. The method of claim 7 wherein said workspace is adapted to be edited.

9. The method of claim 1 wherein said ordering specifics comprising: at least one contract, order ticks, order type, order side, stop, close tick, target, and convert-to-market.

10. The method of claim 1 wherein said order type comprising dynamic, market, and limit.

11. The method of claim 1 wherein said order side comprising buy and sell.

12. The method of claim 1 further comprising auditing activity history in an auditing module.

13. The method of claim 1 further comprising organizing said event information for forecasting and risk management.

14. The method of claim 1 further comprising aggregation said orders triggered in the order execution module.
